(19) United States
(12) Patent Application Publication
(10) Pub. No.: US 2005/0264711 A1
(43) Pub. Date: Dec. 1, 2005

(54) Flat panel display with supporting structure

(76) Inventors: Li-Hui Chen, Hsinchu City (TW); Che-Chih Chang, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/903,780

(22) Filed: Jul. 30, 2004

(30) Foreign Application Priority Data
May 31, 2004 (TW) 93115480

(51) Int. Cl. G02F 1/1333

(52) U.S. Cl. 349/58

(57) ABSTRACT

A flat panel display with supporting structure. The flat panel display includes a frame, a light guide plate, and a first protrusion. The frame has a first edge. The light guide plate is disposed on the frame, comprising a second edge, corresponding to the first edge with a gap therebetween. The first protrusion is sandwiched between the first and second edges.

### BACKGROUND OF THE INVENTION

1. Field of the Invention

The present invention relates to a flat panel display with a supporting structure and in particular to a supporting structure for supporting a panel and a light guide plate.

2. Description of the Related Art

A direct light module for a liquid crystal display (LCD) is supported and protected against damage by a conventional supporting structure. As shown in FIG. 1A, the conventional supporting structure 10 comprises an outer frame 15 and an inner frame 12 having a plurality of hooks 14. The outer frame 15 is commonly made of metal. The inner frame 12 is usually made of plastic. Due to flexible nature of the plastic, the inner frame 12 is connected to the outer frame 15 by the hooks 14 to enhance the strength of the supporting structure 10. As shown in FIG. 1B, the main purpose of the supporting structure 10 is to encase a light guide plate 16 and a panel 19 with other backlight module films thereon. The panel 19 is supported at a bent edge 1223 of the inner frame 12. Since the light guide plate 16 is fragile, it cannot have direct contact with the outer frame 15. Thus, it is encased by the flexible inner frame 12. As the use of liquid crystal displays has grown, the frames 12 and 15 must be assembled as quickly and accurately as possible. However, as shown in FIG. 1A, in the conventional supporting structure 10, having light-weight thin edges 121, 122, 123, and 124 of the inner frame 12, during assembly, the inner frame 12 is easily forced out of square due to forces F from different directions during handling, resulting in inconsistent tension on each edge 121, 122, 123, and 124 of the inner frame 12. Moreover, the distortion of the inner frame 12 frequently, easily detaches the hooks 14 from the outer frame 15. Additionally, the light guide plate 16 is only supported at two corners 1221 and 1222 on one side and one supporting portion 1224 on the other side of the inner frame 12. The panel 19 is supported at a supporting edge 1223 of each edge of the inner frame 12 with a gap 191 between the panel 19 and the inner frame 12. When the inner frame 12 with high flexibility is deformed inwardly, both the light guide plate 16 and the panel 19 are easily displaced accordingly, causing misalignment of the display area, likely to cause Mura defect and rejection of the product.

As mentioned above, the inner and outer frames 12, 15 of the conventional supporting structure 10 are not strongly interconnected, thereby causing detachment of the frames 12 and 15 and dislocation of the light guide plate 16 or the panel 19. To effectively solve the problem, a supporting structure with better connection and higher strength is required to increase stability and ensure correct and exact positioning of the light guide plate and the panel in the frames.

### SUMMARY OF THE INVENTION

Accordingly, an object of the invention is to provide a flat panel display with a supporting structure for a direct light module that can securely encase the light guide plate and the panel within frame.

Another object of the invention is to provide a flat panel display with a supporting structure that can firmly maintain two frames in a stably engaged position during assembly.

The present invention, in one embodiment, provides a flat panel display with a supporting structure comprising a frame, a light guide plate, and a first protrusion. The frame has a first edge. The light guide plate is disposed on the frame, comprising a second edge, corresponding to the first edge with a gap therebetween. The first protrusion is sandwiched between the first and second edges. The frame comprises plastic.

In another embodiment, the flat panel display includes a frame and a panel. The panel is disposed on the frame. The frame has a first edge and a protrusion thereon. The panel has a second edge spaced apart from the first edge by the protrusion.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic perspective view of a conventional supporting structure of a flat panel display;

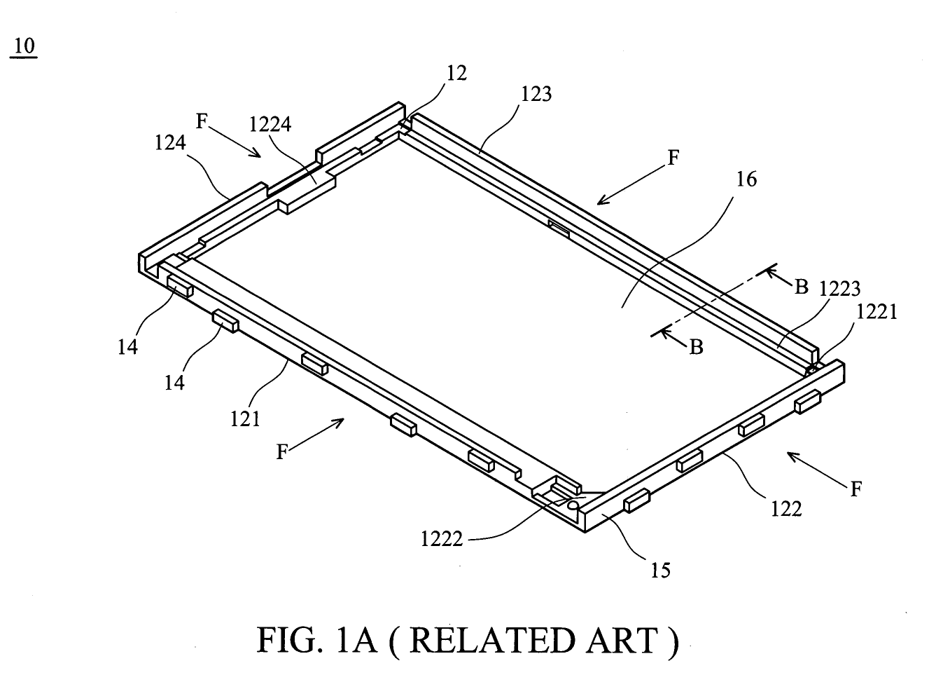

FIG. 1B is a schematic cross section of the conventional supporting structure viewed from a line BB in FIG. 1A;

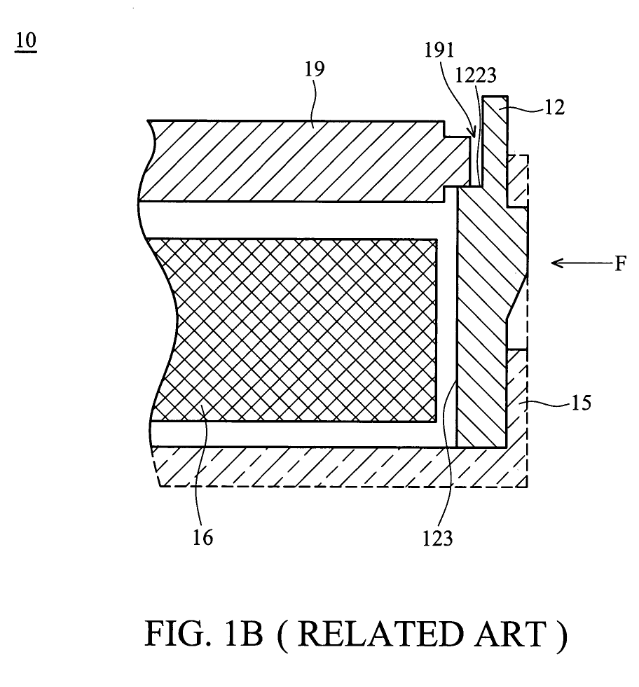

FIG. 2A is a schematic top view of a supporting structure according to the first embodiment of the present invention;

FIG. 2B is a schematic cross section of the supporting structure viewed from a line AA in FIG. 2A;

FIG. 3A is a schematic top view of a supporting structure according to the second embodiment of the present invention;

FIG. 3B is a schematic cross section of the supporting structure viewed from a line AA in FIG. 3A;

FIG. 4A is a schematic top view of a supporting structure according to the third embodiment of the present invention; and

FIG. 4B is a schematic cross section of the supporting structure viewed from a line AA of FIG. 4B.

### DETAILED DESCRIPTION OF THE INVENTION

A detailed description of a flat panel display with a supporting structure as one of the preferred embodiments of the present invention is provided in the following.

### FIRST EMBODIMENT

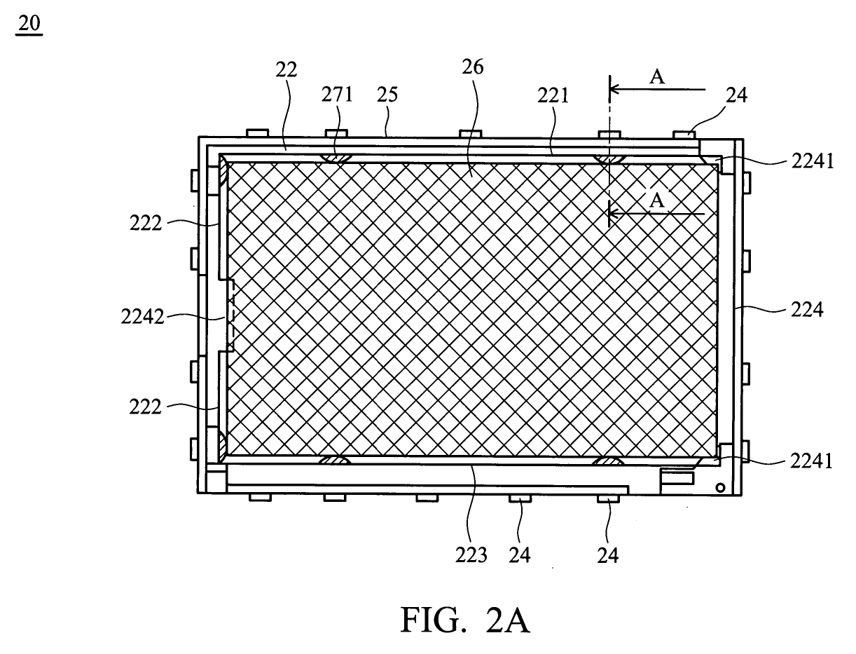

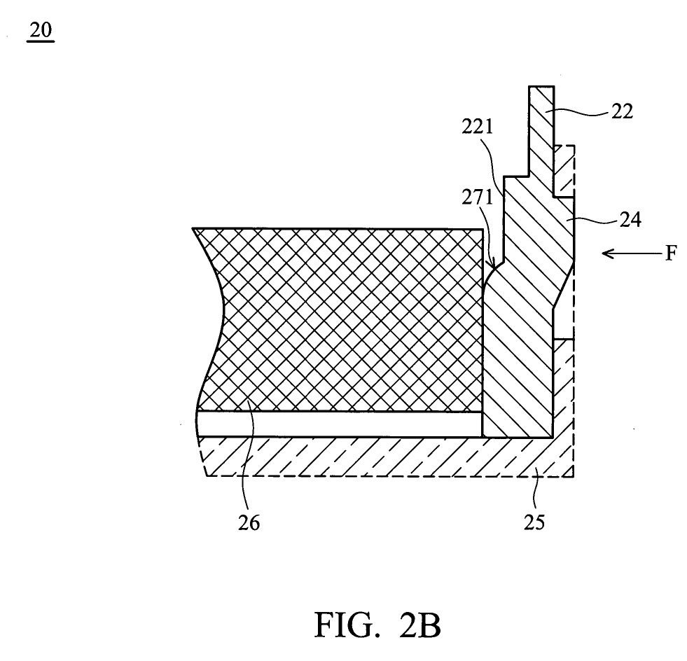

FIG. 2A is a schematic top view of a supporting structure 20 of a flat panel display according to the first embodiment of the present invention. The supporting structure 20 comprises an outer frame 25 and an inner frame 22 to support a light guide plate 26 and panel (not shown). In this embodiment, the outer frame 25 is a metal frame and has a bottom plate (not shown) to protect the elements encased therein. The inner frame 22 is a plastic frame. The inner frame 22 is disposed on the outer frame 25 by hooks 24 thereof. The light guide plate 26, supported by the inner frame 22 is disposed above the bottom plate of the outer frame 25 without contact therebetween.

The inner frame 22 is substantially rectangular and has first, second, third and fourth edges 221, 222, 223, and 224. The second and the fourth edges 222 and 224 are shorter than the first and the third edges 221 and 223. It is sufficient to dispose at least one protrusion 271 on the first and the third edges 221 and 223 to prevent the light guide plate 26 from shifting between the edges of the inner frame 22. In this embodiment, as shown in FIG. 2A, each of the edges 221, 222, and 223 has two protrusions 271 symmetrically disposed thereon. The light guide plate 26 is encased by the inner frame 22 through supporting portions 2241 and 2242 at corners thereof, and adequate protective allowance between the light guide plate 26 and each edge of the inner frame 22 is provided by the protrusion 271, merely providing a point contact with the inner frame 22. Thus, the protrusion 27 serves as an intermediary between the inner frame 22 and the light guide plate 26, not only protecting the light guide plate 26 from damage, but also ensuring correct positioning thereof.

Furthermore, as shown in FIG. 2A, the fourth edge 224 may not require a protrusion 271 since the two corners of the supporting structure 20 along the edge 224 already provide two supporting portions 2241 to space the light guide plate 26 from the edge 224. However, at the other three edges 221, 222, and 223, it is necessary to restrict the light guide plate 26 from direct contact with the edges of the inner frame 22. The number and locations of the protrusions 27 at the other three edges 221, 222, and 223 is not limited. Alternatively, (not shown), more than two protrusions 271 can be evenly or symmetrically formed on any one of the three edges 221, 222, and 223 of the inner frame 22. It is to be noted that at least one protrusion 271 disposed on any one of the three edges 221, 222, and 223 is enough to make sure the light guide plate 16 in its correct position, and it is optional to provide the protrusions 271 on the fourth edge 224.

FIG. 2B is a schematic cross section of the supporting structure viewed from a line AA in FIG. 2A. As shown in FIG. 2B, with protrusions 271 formed at the edges 221, 222, and 223 of the inner frame 22, as force F is applied toward the hook 24, the protrusions 271 prevent the hook 24 of the inner frame 22 from detaching from the outer frame 25 since the hook 24 is abutted by one of the protrusions 271 in a direction opposite to force F. As a result, the inner frame 22 does not deform toward the light guide plate 26, and thus, the present invention provides a more secure connection between the inner and outer frames 22 and 25.

### SECOND EMBODIMENT

The second embodiment provides another flat panel display with a supporting structure 20′ for supporting a light guide plate 26.

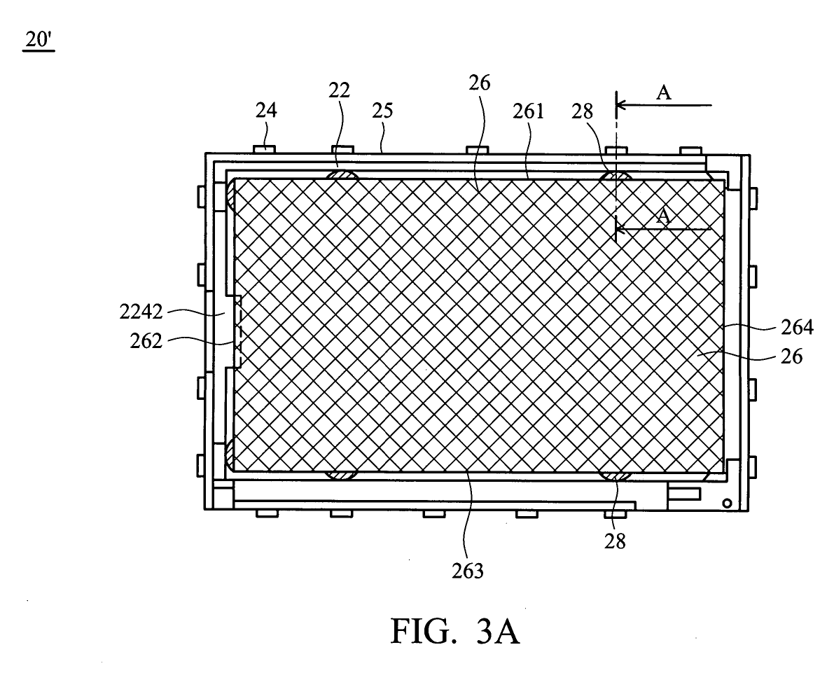

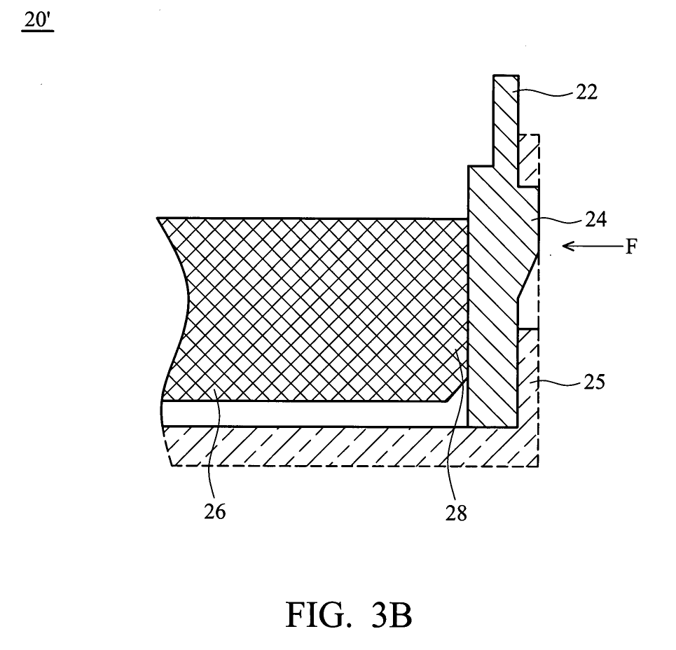

FIG. 3A is a schematic top view of a supporting structure 20′ according to the second embodiment of the present invention. As shown in FIG. 3A, similar to the first embodiment, the supporting structure 20′ includes an outer frame 25, an inner frame 22, and a light guide plate 26. The outer frame 25 is a metal frame. The inner frame 22 is a plastic frame. The inner frame 22 is disposed on the outer frame 25 via a hook 24. The light guide plate 26 is rectangular and has four edges 261, 262, 263, and 264. The second and fourth edges 262 and 264 are shorter than the first and the third edges 261 and 263. It is sufficient to dispose at least one protrusion 28 on the first and the third edges 261 and 263. Similar to the first embodiment, there are two protrusions 28 on each of the edges 261, 262, and 263 shown in FIG. 3. The light guide plate 26 is spaced apart from the rough edges 261, 262, and 263 of the inner frame 22 by the protrusions 28, providing a point contact with the inner frame 22. Thus, the protrusion 28 serves as an intermediary between the inner frame 22 and the light guide plate 26, protecting the light guide plate 26 from damage and ensuring correct display area.

Furthermore, the number and locations of the protrusions 28 is not limited. Alternatively, (not shown), more than two protrusions 28 can be evenly or symmetrically formed on any one of the three edges 261, 262, and 263 of the light guide plate 26.

FIG. 3B is a schematic cross section of the supporting structure viewed from a line AA of FIG. 3A. With the protrusions 28 formed at the edges 261, 262, and 263 of the light guide plate 26, as force F is applied to the hook 24, the protrusions 28 prevent the hook 24 of the inner frame 22 from detaching from the outer frame 25 since the hook 24 is abutted by one of the protrusions 28 in a direction opposite to the force F, as shown in FIG. 3B. As a result, the edges of the inner frame 22 do not deform toward the light guide plate 26, and thus, the present invention provides a more secure connection between the two frames 22 and 25.

### THIRD EMBODIMENT

The third embodiment also provides another flat panel display with supporting structure 20″ for supporting a panel 29, disposed above the light guide plate 26.

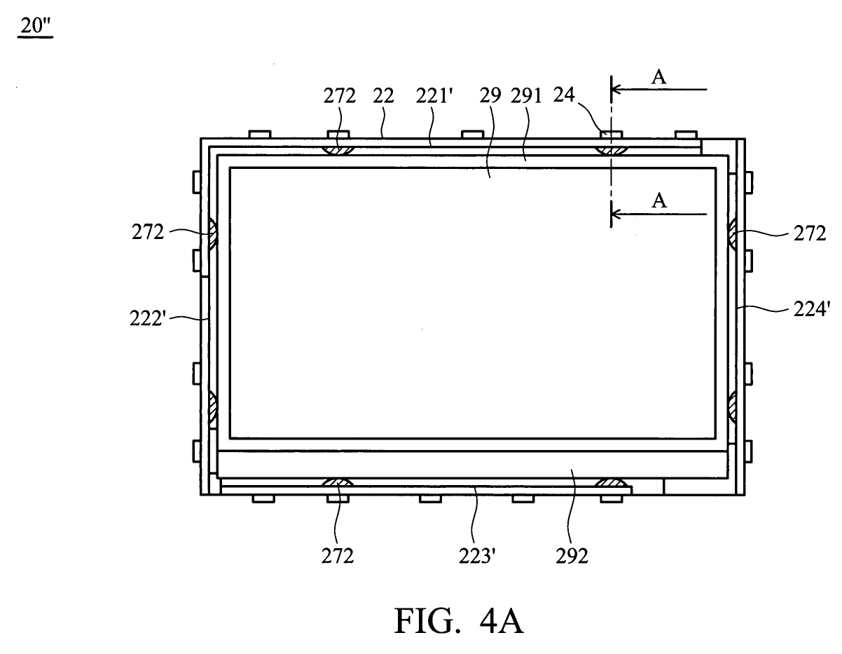

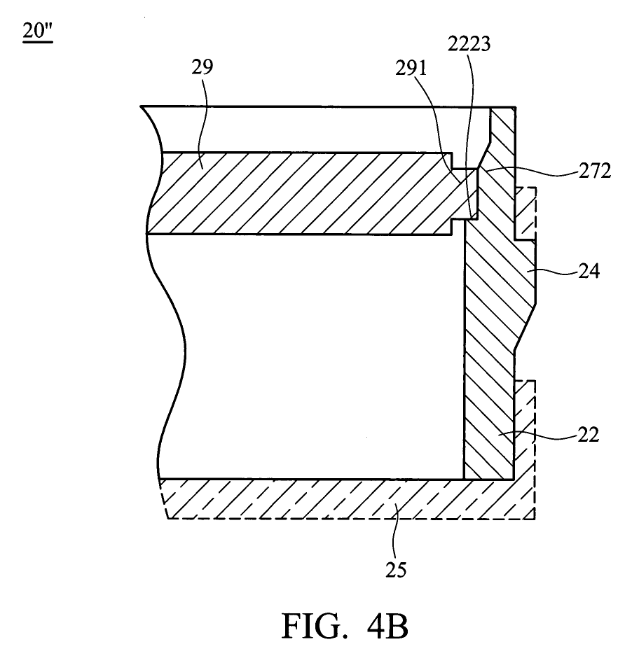

FIG. 4A is a schematic top view of a supporting structure 20″ according to the third embodiment of the present invention. FIG. 4B is a schematic cross section of the supporting structure 20″ viewed from a line AA of FIG. 4A. As shown in FIGS. 4A and 4B, similar to the first embodiment, the supporting structure 20″ includes an outer frame 25 and an inner frame 22 to support the panel 29. The outer frame 25 is a metal frame. The inner frame 22 is a plastic frame. The inner frame 22 is disposed on the outer frame 25 via a hook 24. The inner frame 22 is substantially rectangular and has four edges 221′, 222′, 223′, and 224′. The second and fourth edges 222′ and 224′ are shorter than the first and the third edges 221′ and 223′. It is sufficient to dispose at least one protrusion 272 on the first and the third edges 221′ and 223′. Similar to the first embodiment, in this embodiment, there are two protrusions 272 on each of the edges 221′, 222′, 223′, and 224′ shown in FIG. 4A. The panel 29 is also substantially rectangular, and has a protruding periphery 291. There is a portion 292 on one edge of the panel 29 for integrated circuits disposed thereon. The protruding periphery 291 of the panel 29 is disposed on the bent edge 2223 of the inner frame 22 and spaced apart from the rough edges 221′, 222′, 223′, and 224′ of the inner frame 22 by the protrusions 272, providing merely point contact with the inner frame 22. Thus, the protrusions 272 serve as an intermediary between the inner frame 22 and the panel 29, protecting the panel 29 from damage and ensuring correct display area.

Furthermore, the number and locations of the protrusions 272 is not limited. Alternatively, (not shown), more than two protrusions 272 can be evenly or symmetrically formed on any one of the edges 221′, 222′, 223′ and 224′ of the inner frame 22. As shown in FIG. 4B, with the protrusions 272 formed at the four edges of the inner frame 22, as force F is applied to the hook 24, the protrusions 272 prevent the hook 24 of the inner frame 22 from detaching from the outer frame 25 since the hook 24 is abutted by one of the protrusions 272 in a direction opposite to the force F. As a result, the edges of the inner frame 22 do not deform toward the panel 29, and thus, the present invention provides a more secure connection between the two frames 22 and 25.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A flat panel display with a supporting structure, comprising:
a frame, having a first edge;
a light guide plate, disposed on the frame, comprising a second edge, corresponding to the first edge with a gap therebetween; and
a first protrusion, sandwiched between the first and second edges.

2. The flat panel display as claimed in claim 1, wherein the first protrusion is fixed to the first edge.

3. The flat panel display as claimed in claim 1, wherein the first protrusion is fixed to the second edge.

4. The flat panel display as claimed in claim 1, further comprising a panel disposed on the frame, wherein the frame further has a second protrusion and the panel is spaced apart from the first edge by the second protrusion.

5. The flat panel display as claimed in claim 1, wherein the frame comprises plastic.

6. The flat panel display as claimed in claim 1, further comprising an outer frame, wherein the frame further has a hook, securely connected with the outer frame through the hook.

7. The flat panel display as claimed in claim 6, wherein the outer frame comprises metal.

8. A flat panel display with a supporting structure, comprising:
a frame comprising a first edge and a protrusion thereon; and
a panel, disposed on the frame, comprising a second edge, wherein the second edge is spaced apart from the first edge by the protrusion.

9. The flat panel display as claimed in claim 8, wherein the frame comprises plastic.

10. The flat panel display as claimed in claim 8, further comprising an outer frame, wherein the frame further has a hook, securely connected with the outer frame through the hook.

11. The flat panel display as claimed in claim 10, wherein the outer frame comprises metal.
